(19) United States
(12) Patent Application Publication
(10) Pub. No.: US 2026/0171946 A1
(43) Pub. Date: Jun. 18, 2026

(54) LUENBERGER CURRENT OBSERVER WITH ADAPTIVE GAIN FOR PERMANENT MAGNET SYNCHRONOUS MACHINES IN AUTOMOTIVE APPLICATION

(71) Applicants: Ying ZUO, Montreal (CA); Chunyan LAI, Montreal (CA); Lakshmi Varaha IYER, Troy, MI (US); Anastasiia GALKINA, St. Valentin (AT); Martin GROSSBICHLER, St. Valentin (AT); Martin WINTER, St. Valentin (AT); MAGNA INTERNATIONAL INC., Aurora (CA)

(72) Inventors: Ying ZUO, Montréal (CA); Chunyan LAI, Montréal (CA); Lakshmi Varaha IYER, Troy, MI (US); Anastasiia GALKINA, St. Valentin (AT); Martin GROSSBICHLER, St. Valentin (AT); Martin WINTER, St. Valentin (AT)

(21) Appl. No.: 19/124,356

(22) PCT Filed: Oct. 26, 2023
(86) PCT No.: PCT/US2023/035981

§ 371 Date: Apr. 25, 2025

Related U.S. Application Data
(60) Provisional application No. 63/419,356, filed on Oct. 26, 2022.

(51) Int. Cl. H02P 27/06; H02P 6/18; H02P 21/22

(52) U.S. Cl. CPC H02P 27/06; H02P 6/18; H02P 21/22

(57) ABSTRACT

A method for operating a motor drive to supply power to an electric motor comprises: measuring at least one phase current in the electric motor; measuring a rotational speed of the electric motor; adjusting, based on the rotational speed of the electric motor, at least one observer gain coefficient of an observer gain matrix of a Luenberger Current Observer (LCO); and determining, using the LCO, an estimated motor current of the electric motor. A motor drive comprises: an inverter operable to supply AC power to an electric motor, a current sensor, a speed sensor, and a controller configured to: adjust, based on the rotational speed of the electric motor, at least one observer gain coefficient of an observer gain matrix of a Luenberger Current Observer (LCO). The controller is also configured to determine, using the LCO, an estimated motor current of the electric motor.

### CROSS-REFERENCE TO RELATED APPLICATIONS

This PCT International Patent application claims the benefit of and priority to U.S. Provisional Patent Application Ser. No. 63/419,356, filed Oct. 26, 2022, titled “Luenberger Current Observer With Adaptive Gain For Permanent Magnet Synchronous Machines In Automotive Application,” the entire disclosure of which is hereby incorporated by reference in its entirety.

### FIELD

The present disclosure relates generally to a method and system for controlling a motor drive. More specifically, the method and system of the present disclosure may be used for controlling a motor drive coupled to an electric motor configured as a traction motor for propelling a motor vehicle, such as a passenger car or truck.

### BACKGROUND

Permanent magnet synchronous machines (PMSMs) are widely employed in servo control, automotive, aerospace and wind power generation systems due to their high power density, high efficiency, and simple structure. PMSMs are usually driven by a voltage source inverter, and motor control is performed using inputs such as current, position, and/or voltage measurements. For current measurement, a three-phase PMSM drive usually uses two or three-phase current sensors. Hardware current sensors for measuring such two and three-phase currents have substantial costs. In reality, not only the cost of the sensor itself is considered, but also the cabling, the appropriate connectors and interfaces, and all associated expenses have to be considered as well. Furthermore, current measurement error and noise inevitably exist due to various factors such as device tolerance, temperature drift and aging, and electromagnetic interference (EMI), which worsen the PMSM control performance. Failure of current sensors is most critical to the drive system. Even if only one current sensor malfunctions, it can prevent normal operation of a motor drive. Therefore, high accuracy three-phase current reconstruction has risen manufacturers' interest as they seek to reduce costs and improve robustness for the PMSM drive system.

Precision in conventional three-phase current estimation methods is largely affected by dead zones in the space vector pulse width modulation plane, and requires additional efforts to compensate for the dead zones for a single DC link current sensor based method. Furthermore, a DC link sensor is not available for all three phase PMSM drive systems. Single phase current sensor based methods may use current observers with one phase current sensor to reconstruct three-phase current signals. A Luenberger observer may be used for current reconstruction. However, conventional Luenberger observers employ a constant gain matrix, which cannot guarantee observer performance under time-varying speed and system parameter conditions as it is the case in automotive applications. A possible solution may be to use more advanced observer concepts such as, e.g. Extended Kalman Filter which are able to handle time-varying system parameters. However, the design of a covariance matrix for a Kalman filter based method is not straightforward and it suffers from a heavy computational burden.

### SUMMARY

The present disclosure provides a method for operating a motor drive configured to supply power to an electric motor. The method, comprises: measuring at least one phase current in the electric motor; measuring a rotational speed of the electric motor; adjusting, based on the rotational speed of the electric motor, at least one observer gain coefficient of an observer gain matrix of a Luenberger Current Observer (LCO); and determining, using the LCO, an estimated motor current of the electric motor.

The present disclosure also provides a motor drive system. The motor drive system comprises: an inverter having at least one pair of switches operable to supply an alternating current (AC) power to an electric motor; a current sensor configured to measure at least one phase current in the electric motor; a sensor configured to measure a rotational speed of the electric motor; and a controller. The controller is configured to adjust, based on the rotational speed of the electric motor, at least one observer gain coefficient of an observer gain matrix of a Luenberger Current Observer (LCO). The controller is also configured to determine, using the LCO, an estimated motor current of the electric motor.

### BRIEF DESCRIPTION OF THE DRAWINGS

Further details, features and advantages of designs of the invention result from the following description of embodiment examples in reference to the associated drawings.

FIG. 1 shows a schematic block diagram of a system, in accordance with an aspect of the present disclosure;

FIG. 2 shows a schematic block diagram of a motor drive system, in accordance with an aspect of the present disclosure;

FIGS. 3A-3F each show a graph illustrating performance of a motor drive of the present disclosure and over a common time scale;

FIGS. 4A-4B show graphs of d-axis current and q-axis current, respectively, illustrating performance of a Luenberger current observer in the motor drive, in accordance with an aspect of the present disclosure; and

FIG. 5 shows a flow chart of steps in a method for operating a motor drive, in accordance with some embodiments of the present disclosure.

### DETAILED DESCRIPTION

Referring to the drawings, the present invention will be described in detail in view of following embodiments.

To overcome the technical limitations of the existing approaches, a novel Luenberger current observer structure with speed adaptive gain for three phase current reconstruction is proposed. A fourth-order PMSM modelling considering system uncertainties and unknown external disturbance in a synchronous rotating frame is proposed. Based on the proposed PMSM modelling, the Luenberger current observer with speed adaptation is also provided. The effectiveness of the proposed method is verified through simulation.

The present disclosure provides a new Luenberger current observer structure with speed adaptive gain for permanent magnet synchronous machine (PMSM) drives in electric vehicle applications considering parameter variation. Firstly, the fourth-order PMSM modelling in a synchronous rotating frame is built to consider system uncertainties and unknown external disturbance. Based on the machine modelling, Luenberger current observer is designed with a speed adaptive gain and improved stability. The proposed Luenberger current observer structure can achieve high accuracy three phase current reconstruction with only one phase current sensor in the drive system. It can be applied in the following fields for PMSM drives in electric vehicles: 1) eliminate current sensor measurement error and noise; 2) current sensor fault tolerant control; and 3) reduce the number of current sensors in a three-phase PMSM drive system. The effectiveness of the proposed method has been verified through simulation.

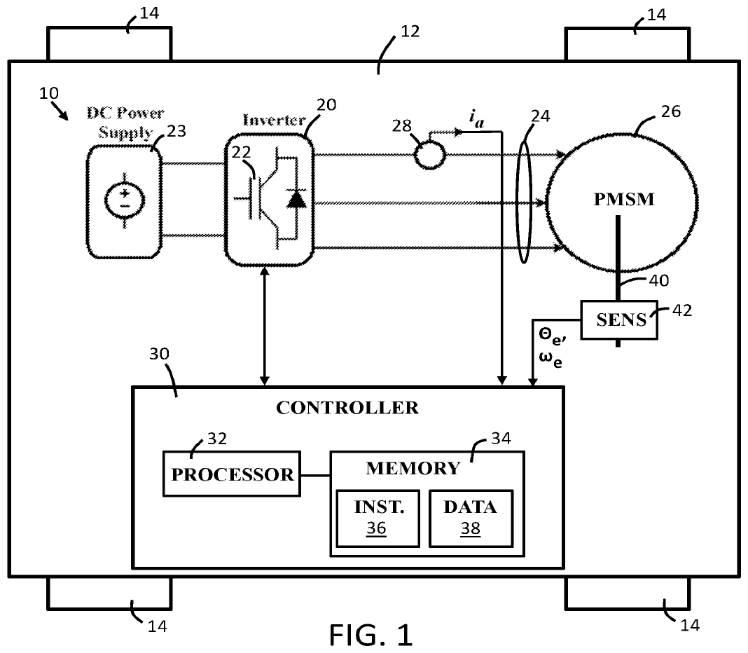

FIG. 1 shows a block diagram of system 10 in accordance with an aspect of the present disclosure. The system 10 is provided in a vehicle 12 having four wheels 14. The system 10 includes an inverter 20 having one or more pairs of solid-state switches 22, such as field effect transistors (FETs) configured to switch current from a DC power supply 23 and to generate an AC power upon a set of motor leads 24. The motor leads 24 transmit electrical power between the inverter 20 and an electric motor 26. The electric motor 26 may be a permanent magnet synchronous motor (PMSM). The electric motor 26 is shown as a 3-phase machine, however, the electric motor 26 may have any number of phases. For example, the electric motor 26 may be a 3-phase machine or a higher-order multiphase machine. The electric motor 26 may be used as a motor, a generator, or as a motor/generator that functions as both a motor and a generator. The electric motor 26 may be coupled to one or more of the wheels 14 of the vehicle 12 for driving the vehicle 12. Alternatively, the electric motor 26 may be used for one or more ancillary functions in the vehicle 12, such as for operating an actuator, a fan, a pump, etc. In some embodiments, the system 10 of the present disclosure may have a non-vehicular application, such as for motor control in industrial or manufacturing applications.

A current sensor 28 is arranged to measure current in one of the motor leads 24. In some embodiments, and as shown on FIG. 1, the current sensor 28 measures an A-phase current iₐ on a corresponding one of the motor leads 24. However, the system 10 may measure current on any one or more of the motor leads 24. The system 10 may include other sensors, such as voltage sensors configured to measure voltages upon or between the motor leads 24.

The system 10 of FIG. 1 also includes an electronic control unit (ECU) 30 in communication with the current sensor 28 to measure the currents in the motor leads 24. The ECU 30 may also be in functional communication with the inverter 20 to control operation of the inverter 20 and/or to monitor parameters measured by sensors associated with the inverter 20. The ECU 30 includes a processor 32 coupled to a storage memory 34. The storage memory 34 stores instructions, such as program code for execution by the processor 32, in an instruction storage 36. The storage memory 34 also includes data storage 38 for holding data to be used by the processor 32. The data storage 38 may record, for example, values of the parameters measured by the current sensor 28 and/or the outcome of functions calculated by the processor 32.

A speed/position sensor 42 may measure a rotational position θ of the electric motor 26 that corresponds to an electrical rotational position θₑ. Alternatively or additionally, the speed/position sensor 42 may measure a rotational speed ω of the electric motor 26 that corresponds to an electrical rotational speed ωₑ of the electric motor 26. In some embodiments, the speed/position sensor 42 may include an encoder or a resolver connected to a shaft 40 of the electric motor 26. The speed/position sensor 42 may communicate the rotational position θ and/or the rotational speed ω of the electric motor 26 to the ECU 30.

### Mathematical Model of PMSMs

The machine equations for a PMSM in the rotating direct-quadrature (dq) reference frame considering system uncertainties and unknown external disturbance can be represented as shown in equations (1) and (2):

$$\{ \begin{matrix}{u}_{d} = {R}_{s} {i}_{d} + {L}_{d} \frac{d {i}_{d}}{d t} - {ω}_{e} {L}_{q} {i}_{q} + {f}_{d} \\ {u}_{q} = {R}_{s} {i}_{q} + {L}_{q} \frac{d {i}_{q}}{d t} + {ω}_{e} {L}_{d} {i}_{d} + {ω}_{e} {ψ}_{f} + {f}_{q}\end{matrix} \qquad ( 1 )$$

$$\{ \begin{matrix}{f}_{d} = Δ {R}_{s} {i}_{d} + Δ {L}_{d} \frac{{di}_{d}}{dt} - {ω}_{e} Δ {L}_{q} {i}_{q} + {E}_{d} \\ {f}_{q} = Δ {R}_{s} {i}_{q} + Δ {L}_{q} \frac{{di}_{q}}{dt} + {ω}_{e} Δ {L}_{d} {i}_{d} + {ω}_{e} Δ {ψ}_{f} + {E}_{q}\end{matrix} \qquad ( 2 )$$

where u_{d}, and u_{q} represent d-axis and q-axis voltages, respectively; iₐ and i_{q} represent d-axis and q-axis currents, respectively; L_{d} and L_{q} represent d-axis and q-axis inductances, respectively; r is permanent magnet flux linkage; Rₛ is the winding resistance; ωₑ is the electrical rotational speed; f_{d}, and f_{q} represent system uncertainties and unknown external disturbance in the d-axis and q-axis, respectively; ΔRₛ, ΔL_{q}, ΔL_{d} and Δψ_{f} are parameter variation terms between real motor parameter and corresponding nominal parameters. E_{d} and E_{q} represent d-axis and q-axis unknown external disturbance terms, respectively.

Assuming resistance variation, inductance variation, permanent magnetic flux linkage variation and external disturbance variation are small and can be ignored, the dynamic equation of an interior PMSM (IPMSM) in the dq-axis can be represented as equation (3):

$$\{ \begin{matrix}\frac{{di}_{d}}{dt} = \frac{{u}_{d}}{{L}_{d}} - \frac{{R}_{s}}{{L}_{d}} {i}_{d} + \frac{{ω}_{e} {L}_{q}}{{L}_{d}} {i}_{q} - \frac{{f}_{d}}{{L}_{d}} \\ \frac{{di}_{q}}{dt} = \frac{{u}_{q}}{{L}_{q}} - \frac{{R}_{s}}{{L}_{q}} {i}_{q} - \frac{{ω}_{e} {L}_{d}}{{L}_{q}} {i}_{q} - \frac{{ω}_{e} {ψ}_{f}}{{L}_{q}} - \frac{{f}_{q}}{{L}_{q}} \\ \frac{{df}_{d}}{dt} = 0 \\ \frac{{df}_{q}}{dt} = 0\end{matrix} \qquad ( 3 )$$

Design of Luenberger Current Observer with Adaptive Gain

The PMSM state space model developed is given as shown in equation (4):

$$\{ \begin{matrix}\frac{d x}{d t} = A x + B u \\ y = C x\end{matrix} \qquad ( 4 )$$

where A, B, and C are each respectively defined as:

$$A = [ \begin{matrix}- \frac{{R}_{s}}{{L}_{d}} & \frac{{L}_{q}}{{L}_{d}} {ω}_{e} & - \frac{1}{{L}_{d}} & 0 \\ - \frac{{L}_{d}}{{L}_{q}} {ω}_{e} & - \frac{{R}_{s}}{{L}_{q}} & 0 & - \frac{1}{{L}_{q}} \\ 0 & 0 & 0 & 0 \\ 0 & 0 & 0 & 0\end{matrix} ] , B = [ \begin{matrix}\frac{1}{{L}_{d}} & 0 \\ 0 & \frac{1}{{L}_{q}} \\ 0 & 0 \\ 0 & 0\end{matrix} ] ,$$

$$C = [ \begin{matrix}1 & 0 & 0 & 0 \\ 0 & 1 & 0 & 0\end{matrix} ] ,$$

and where x=[i_{d} i_{q} f_{d} f_{q}]^{T} is the state vector, u=[u_{d} (u_{q}−ψ_{f}ωₑ)]^{T} is the input vector, and y=[i_{d} i_{q}]^{T} is the output vector.

The observer structure can be written as equation (5):

$$\{ \begin{matrix}\frac{d \hat{x}}{dt} = A \hat{x} + Bu + K ( y - \hat{y} ) \\ \hat{y} = C \hat{x}\end{matrix} \qquad ( 5 )$$

$$where K = {[ \begin{matrix}{k}_{1} & {k}_{2} & {k}_{3} & {k}_{4} \\ {k}_{5} & {k}_{6} & {k}_{7} & {k}_{8}\end{matrix} ]}^{T}$$

is the observer gain matrix and the superscript T represents the transpose of the matrix; k₁, k₂, . . . , k₈ are the observer gain coefficients that remain to be determined. The symbol “\hat{ }” represents the estimated value. In the Luenberger observer, the system dynamic performance is determined by eigenvalues of (A-KC). The speed variation will affect the observer's performance to a large extent if gain matrix K has constant values. Therefore, the present disclosure provides a speed-adaptive gain matrix K to make the Luenberger observer's dynamic performance independent with speed. Values for the speed-adaptive gain matrix K can be derived by the pole placement method as shown in equation (6):

$$\begin{matrix}K = {[ \begin{matrix}{k}_{1} & {k}_{2} & {k}_{3} & {k}_{4} \\ {k}_{5} & {k}_{6} & {k}_{7} & {k}_{8}\end{matrix} ]}^{T} \\ = {[ \begin{matrix}( \frac{- {R}_{s}}{{L}_{d}} ) + 2 {ξω}_{n} & \frac{- {L}_{d}}{{L}_{q}} {ω}_{e} & - {L}_{d} {ω}_{n}^{2} & 0 \\ \frac{{L}_{q}}{{L}_{d}} {ω}_{e} & ( \frac{- {R}_{s}}{{L}_{q}} ) + 2 {ξω}_{n} & 0 & - {L}_{q} {ω}_{n}^{2}\end{matrix} ]}^{T}\end{matrix} \qquad ( 6 )$$

where ωₙ represents the observer natural frequency and ζ represents the observer damping ratio.

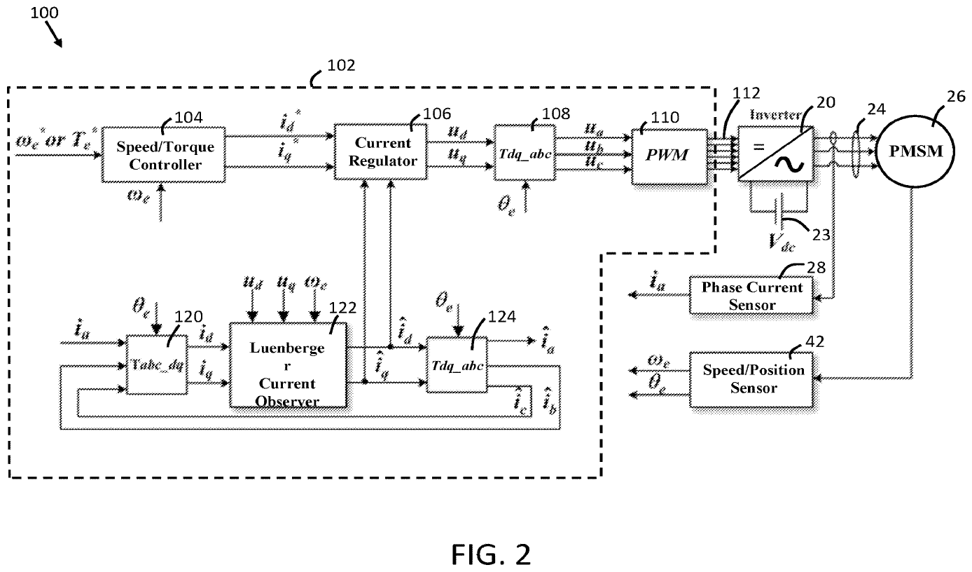

It can be seen that in the K matrix, only k₂ and k₅ change linearly with the rotational speed of the PMSM. All other gain coefficients are constant. Therefore, once the natural frequency of the observer ωₙ and the damping ratio of the observer ζ are determined in the observer, the observer performance will keep unchanged as long as k₂ and k₅ are adaptive online based on speed. By selecting ζωₙ properly, the state observer will have a good dynamic performance under all operating conditions with the proposed adaptive gain design. It should be noted that the proposed adaptive gain matrix has the advantages of speed adaption and does not suffer from heavy computational burden. With this adaptive gain matrix, the Luenberger current observer can achieve high accuracy three phase current reconstruction with improved stability. The Luenberger current observer of the present disclosure can be used to reconstruct three phase current signals with only one of the current sensor 28, as shown in FIG. 2.

The coordinate transformations in FIG. 2 are defined as shown in equations (7) and (8):

$${T}_{{abc}_{\_ d q}} = \frac{2}{3} [ \begin{matrix}cos ( {θ}_{e} ) & cos ( {θ}_{e} - \frac{2 π}{3} ) & cos ( {θ}_{e} + \frac{2 π}{3} ) \\ - sin ( {θ}_{e} ) & - sin ( {θ}_{e} - \frac{2 π}{3} ) & - sin ( {θ}_{3} + \frac{2 π}{3} )\end{matrix} ] \qquad ( 7 )$$

$${T}_{{dq}_{\_ abc}} = [ \begin{matrix}cos ( {θ}_{e} ) & - sin ( {θ}_{e} ) \\ cos ( {θ}_{e} - \frac{2 π}{3} ) & - sin ( {θ}_{e} - \frac{2 π}{3} ) \\ cos ( {θ}_{e} + \frac{2 π}{3} ) & - sin ( {θ}_{e} + \frac{2 π}{3} )\end{matrix} ] \qquad ( 8 )$$

where θₑ is the electrical rotor position.

A schematic block diagram of a motor drive system 100 in accordance with an aspect of the present disclosure is shown in FIG. 2. The motor drive system 100 includes a controller 102 that is configured to implement several computational functions. The controller 102 may include the ECU 30 and may implement the associated functions in hardware, software, or in a combination of hardware and software. The controller 102 includes a speed/torque controller 104 configured to generate a current command

$${i}_{d}^{*} , {i}_{q}^{*} .$$

The speed/torque controller 104 may use a control loop, such as a proportional-integral (PI) loop or a proportional-integral-derivative (PID) loop to generate the current command

$${i}_{d}^{*} , {i}_{q}^{*} .$$

The speed/torque controller 104 may be configured as a speed controller to cause the electric motor 26 to rotate at the electrical rotational speed ωₑ in accordance with a speed command

$${ω}_{e}^{*} .$$

Alternatively or additionally, the speed/torque controller 104 may be configured as a torque controller to cause the electric motor 26 to produce an output torque in accordance with a torque command

$${T}_{e}^{*} .$$

The controller 102 also includes a current regulator 106 configured to generate a voltage signal u_{d}, u_{q} based on the current command

$${i}_{d}^{*} , {i}_{q}^{*}$$

and based on an estimated current command î_{d}, î_{q}. The voltage signal u_{d}, u_{q} includes d-axis and q-axis voltage values, respectively, representing a voltage to be applied by the inverter 20 to the electric motor 26. The current regulator 106 may use a control loop, such as a proportional-integral (PI) loop or a proportional-integral-derivative (PID) loop to generate the voltage signal u_{d}, u_{q}.

The controller 102 also includes a first dq-abc transformer 108 configured to compute phase voltages uₐ, u_{b}, u_{c} based on the voltage signal u_{d}, u_{q} in the dq reference frame and based on the electrical rotational position De of the electric motor 26. The first dq-abc transformer 108 may implement an inverse direct-quadrature-zero transformation such as the transformation described in equation (8).

The controller 102 also includes a pulse-width modulator (PWM) 110 configured to generate a plurality of gate driver signals 112 for controlling switching devices of the inverter 20 to cause the inverter 20 to generate AC power on the motor leads 24 corresponding to the phase voltages uₐ, u_{b}, u_{c}.

The controller 102 also includes an abc-dq transformer 120 configured to compute a preliminary estimated motor current i_{d}, i_{q} that includes a preliminary estimated d-axis current i_{d} and a preliminary estimated q-axis current i_{q} based on phase current signals iₐ, î_{b}, î_{c}. The abc-dq transformer 120 may implement a direct-quadrature-zero transformation such as the transformation described in equation (7).

The controller 102 also includes a Luenberger Current Observer (LCO) 122 configured to calculate an estimated motor current î_{d}, î_{q} based on the preliminary estimated motor current i_{d}, i_{q}, the voltage signal u_{d}, u_{q}, and the electrical rotational speed we of the electric motor 26. The LCO 122 may implement the observer structure described, above and as represented by equation (5). The LCO 122 may include an observer gain matrix with a plurality of observer gain coefficients k₁, k₂ . . . k₈. In some embodiments the controller 102 may be configured to adjust at least one of the observer gain coefficients k₁, k₂ . . . k₈ based on the electrical rotational speed de of the electric motor 26. For example, observer gain coefficients k₂ and k₅ may each be adjusted linearly with the electrical rotational speed ωₑ of the electric motor 26.

The controller 102 also includes a second dq-abc transformer 124 configured to compute estimated phase currents îₐ, î_{b}, î_{c} based on the estimated motor current î_{d}, î_{q} in the dq reference frame and based on the electrical rotational position θₑ of the electric motor 26. The second dq-abc transformer 124 may implement an inverse direct-quadrature-zero transformation such as the transformation described in equation (8).

### Performance Evaluation

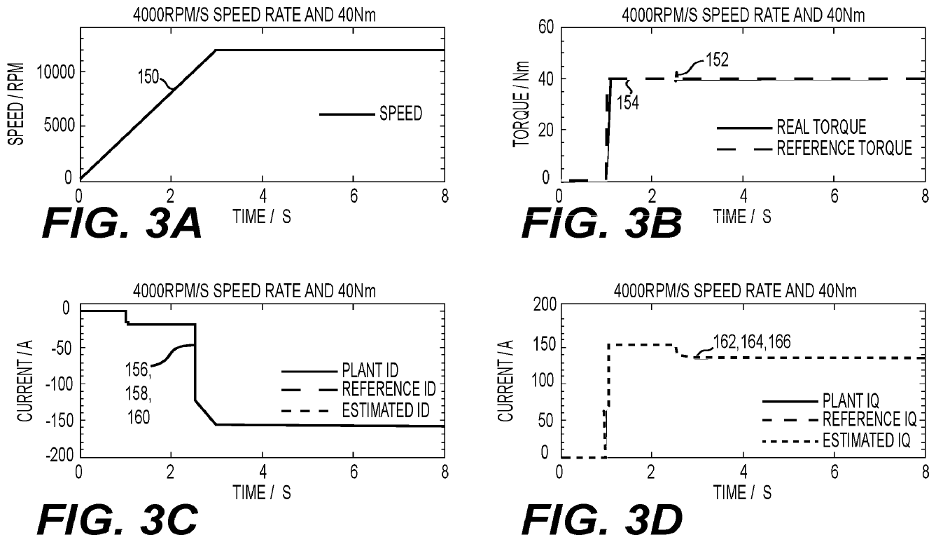

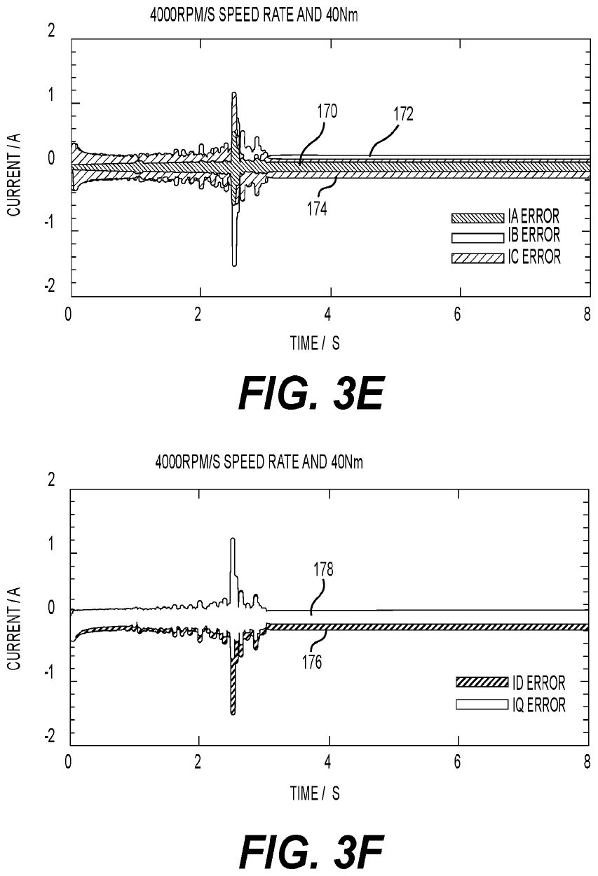

To verify the performance of the proposed Luenberger current observer based three phase current reconstruction method, simulations were carried out on the MATLAB/Simulink platform. The reconstructed phase current results when only one hardware current sensor is used in PMSM drive system are shown in FIGS. 3E-3F. The PMSM starts from zero speed to maximum speed (12000 rpm) with rated torque (40 Nm). FIGS. 3E-3F, the plant idq currents are actual dq-axis motor currents, estimated idq currents are estimated current from Luenberger current observer and reference idq currents are current controller reference currents. The dq-axis current errors are between real dq-axis motor currents and estimated current from Luenberger current observer. Based on the results, it can be concluded that the motor can operate under single current sensor control with the proposed Luenberger current observer structure.

FIGS. 3A-3F each show a graph illustrating performance of a motor drive of the present disclosure and over a common time scale. FIG. 3A includes a first plot 150 of rotational speed of the electric motor 26 in revolutions-per-minute (RPM). FIG. 3B includes a second plot 152 of real or actual torque in Newton-Meters (Nm) produced by the electric motor 26, and a third plot 154 of reference torque (in Nm) corresponding to the torque command

$${T}_{e}^{*} .$$

FIG. 3C shows plots 156, 158, 160 of d-axis current in Amperes (A) including a plot 156 of actual d-axis current (Plant id) in the windings of the electric motor 26. FIG. 3C also shows a plot 158 of reference d-axis current corresponding to the current command

$${i}_{d}^{*} ,$$

and a plot 160 of estimated d-axis current corresponding to the estimated motor current î_{d}, calculated by the LCO 122. FIG. 3D shows plots 162, 164, 166 of q-axis current in Amperes (A) including a plot 162 of actual q-axis current (Plant iq) in the windings of the electric motor 26. FIG. 3D also shows a plot 164 of reference q-axis current corresponding to the current command

$${i}_{q}^{*} ,$$

and a plot 166 of estimated q-axis current corresponding to the estimated motor current î_{q} calculated by the LCO 122.

FIG. 3E shows plots 170, 172, 174 of error, or differences between estimated phase currents and actual phase currents in Amperes (A). FIG. 3E includes a first plot 170 showing a-phase error, a second plot 172 showing b-phase error and a third plot 174 showing c-phase error. FIG. 3F shows plots 176, 178 of error, or differences between estimated and actual d-axis and q-axis currents in Amperes (A). FIG. 3F includes a plot of d-axis current error 174 representing the difference between estimated and actual d-axis currents. FIG. 3F also includes a plot of q-axis current error 176 representing the difference between estimated and actual q-axis currents.

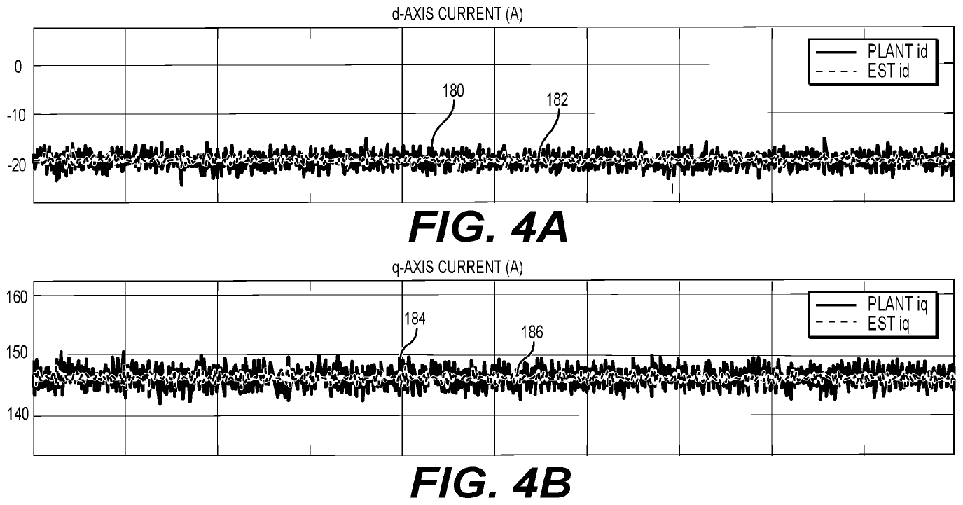

FIGS. 4A-4B show graphs of d-axis current and q-axis current, respectively, illustrating performance of a Luenberger current observer 122 in the motor drive system 100, and over a common time scale. FIG. 4A includes a first plot 180 showing actual d-axis current in the electric motor 26 (Plant id) and a second plot 182 showing estimated d-axis current, as calculated by the LCO 122. FIG. 4B includes a third plot 184 showing actual q-axis current in the electric motor 26 (Plant iq) and a fourth plot 186 showing estimated q-axis current, as calculated by the LCO 122.

The current noise rejection ability of the proposed Luenberger current observer in single current sensor control is shown in FIGS. 4A-4B with 1e-4 current power noise added into the feedback three phase currents in the simulation. Compared with actual dq-axis motor currents, estimated dq-axis currents from Luenberger current observer contain less noise. Therefore, the proposed Luenberger observer has a good current noise rejection ability.

This present disclosure provides a novel Luenberger current observer structure with speed adaptive gain for three phase current reconstruction in PMSM drives for electric vehicle application. The design of the proposed Luenberger current observer provides adaptive tracking of stator current under different speed scenarios without heavy computational burden. The results demonstrate the accuracy and effectiveness of the proposed method. The proposed method can be applied in the following fields for PMSM drives: 1) eliminate current sensor measurement error and noise; 2) current sensor fault-tolerant control; and 3) reduce the number of current sensors in a three-phase PMSM drive system.

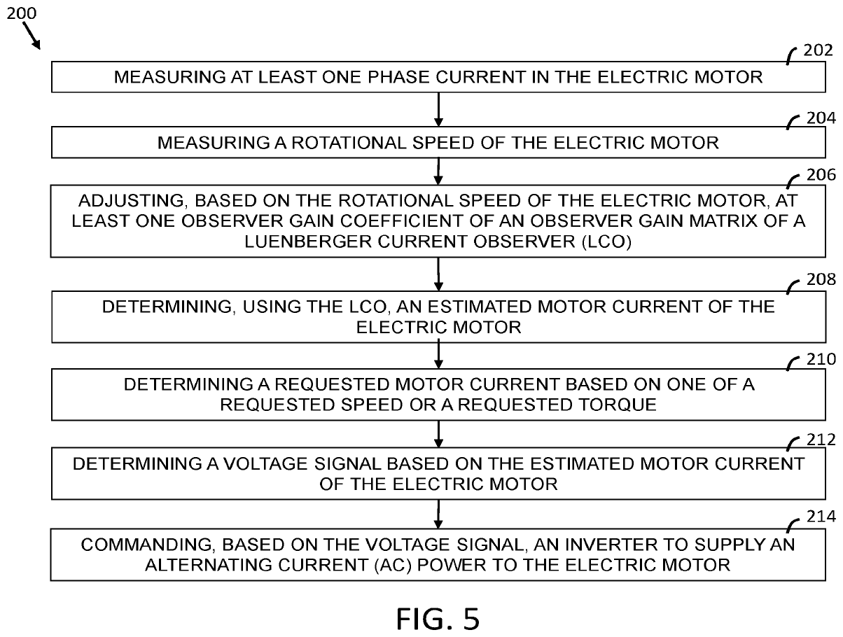

A method 200 for operating a motor drive configured to supply power to an electric motor 26 is shown in the flow chart of FIG. 5. In some embodiments, the electric motor 26 is a PMSM. The method 200 can be performed by the ECU 30, in accordance with some embodiments of the present disclosure. As can be appreciated in light of the disclosure, the order of operation within the method is not limited to the sequential execution as illustrated in FIG. 5, but may be performed in one or more varying orders as applicable and in accordance with the present disclosure.

The method 200 includes measuring at least one phase current in the electric motor at step 202. Step 202 may be performed by the phase current sensor 28.

The method 200 also includes measuring a rotational speed of the electric motor at step 204. Step 204 may be performed by a speed sensor or a position sensor operably coupled to the electric motor, such as the position sensor 42. In some embodiments, the rotational speed of the electric motor may be communicated to the ECU 30 from an external source, such as a controller associated with another system in the vehicle 12.

The method 200 also includes adjusting, based on the rotational speed of the electric motor, at least one of the observer gain coefficient of an observer gain matrix of a Luenberger Current Observer (LCO) at step 206. Step 206 may be performed, for example, by the processor 32 executing program instructions for augmenting or updating the observer gain coefficients of the LCO 122.

The method 200 also includes determining, using the LCO, an estimated motor current of the electric motor at step 208. Step 208 may be performed, for example, by the processor 32 executing program instructions to implement the LCO 122. In some embodiments, step 208 includes determining a preliminary estimated motor current based on the at least one phase current. For example, the processor 32 executing program instructions to implement the abc-dq transformer 120 to compute the preliminary estimated motor current i_{d}, i_{q}. In some embodiments, step 204 also includes refining, by the LCO, the preliminary estimated motor current to determine the estimated motor current of the electric motor. Step 208 may include using one or more techniques for determining the estimated motor current, such as one or more calculations and/or using one or more lookup tables.

The method 200 also includes determining a requested motor current based on one of a requested speed or a requested torque at step 210. Step 210 may be performed, for example, by the processor 32 executing program instructions to implement the speed/torque controller 104.

The method 200 also includes determining a voltage signal based on the estimated motor current of the electric motor at step 212. Step 212 may be performed, for example, by the processor 32 executing program instructions to implement the current regulator 106. Step 212 may include determining a difference between the requested motor current and the estimated motor current. In some embodiments, step 212 may include determining the voltage signal based on the difference between the requested motor current and the estimated motor current.

The method 200 also includes commanding, based on the voltage signal, an inverter to supply an alternating current (AC) power to the electric motor at step 214. Step 214 may be performed, for example, by the processor 32 executing program instructions to implement the first dq-abc transformer 108 and the pulse-width modulator 110 to generate the gate driver signals 112 for controlling switching devices of the inverter 20.

The present disclosure provides a method for operating a motor drive configured to supply power to an electric motor. The method, comprises: measuring at least one phase current in the electric motor; measuring a rotational speed of the electric motor; adjusting, based on the rotational speed of the electric motor, at least one observer gain coefficient of an observer gain matrix of a Luenberger Current Observer (LCO); and determining, using the LCO, an estimated motor current of the electric motor.

In some embodiments, the electric motor is a permanent magnet synchronous machine (PMSM).

In some embodiments, adjusting at least one of the observer gain coefficients includes adjusting two of the observer gain coefficients based on the rotational speed of the electric motor.

In some embodiments, adjusting at least one of the observer gain coefficients includes adjusting the at least one of the observer gain coefficients as a linear function of the rotational speed of the electric motor.

In some embodiments, the observer gain matrix has the form K=

$${[ \begin{matrix}{k}_{1} & {k}_{2} & {k}_{3} & {k}_{4} \\ {k}_{5} & {k}_{6} & {k}_{7} & {k}_{8}\end{matrix} ]}^{T}$$

and k₁, k₂, . . . k₈ are the observer gain coefficients.

In some embodiments, measuring the at least one phase current includes measuring exactly one phase current by a phase current sensor.

In some embodiments, estimating the estimated motor current of the electric motor includes determining, by the LCO, an estimated d-axis current of the electric motor and an estimated q-axis current of the electric motor.

In some embodiments, estimating the estimated motor current of the electric motor includes computing, using a dq-abc transformer, estimated phase currents of the electric motor based on the estimated d-axis current and the estimated q-axis current of the electric motor.

In some embodiments, estimating the estimated motor current of the electric motor includes: determining a preliminary estimated motor current based on the at least one phase current; and refining, by the LCO, the preliminary estimated motor current to determine the estimated motor current of the electric motor.

In some embodiments, the method further includes: determining a voltage signal based on the estimated motor current of the electric motor; and commanding, based on the voltage signal, an inverter to supply an alternating current (AC) power to the electric motor.

In some embodiments, the method further comprises: determining a requested motor current based on one of a requested speed or a requested torque; and determining a difference between the requested motor current and the estimated motor current. In some embodiments, determining the voltage signal based on the estimated motor current of the electric motor further includes determining the voltage signal based on the difference between the requested motor current and the estimated motor current.

The present disclosure also provides a motor drive. The motor drive comprises: an inverter having at least one pair of switches operable to supply an alternating current (AC) power to an electric motor; a current sensor configured to measure at least one phase current in the electric motor; a sensor configured to measure a rotational speed of the electric motor, and a controller. The controller is configured to adjust, based on the rotational speed of the electric motor, at least one observer gain coefficient of an observer gain matrix of a Luenberger Current Observer (LCO). The controller is also configured to determine, using the LCO, an estimated motor current of the electric motor.

In some embodiments, the electric motor is a permanent magnet synchronous machine (PMSM).

In some embodiments, the controller is further configured to adjust at least one of the observer gain coefficients by adjusting the at least one of the observer gain coefficients as a linear function of the rotational speed of the electric motor.

In some embodiments, the current sensor includes a phase current sensor configured to measure the at least one phase current as exactly one phase current.

In some embodiments, the sensor configured to measure the rotational speed of the electric motor includes one of a speed sensor or a position sensor.

In some embodiments, the controller is further configured to: determine a voltage signal based on the estimated motor current of the electric motor; and command, based on the voltage signal, the inverter to supply the alternating current (AC) power to the electric motor.

In some embodiments, the controller is further configured to: determine a requested motor current based on one of a requested speed or a requested torque; and determine a difference between the requested motor current and the estimated motor current. In some embodiments, determining the voltage signal based on the estimated motor current of the electric motor includes the controller being further configured to determine the voltage signal based on the difference between the requested motor current and the estimated motor current.

In some embodiments, estimating the estimated motor current of the electric motor includes the controller being configured to: determine a preliminary estimated motor current based on the at least one phase current; and refine, by the LCO, the preliminary estimated motor current to determine the estimated motor current of the electric motor.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for operating a motor drive configured to supply power to an electric motor, comprising:
measuring at least one phase current in the electric motor;
measuring a rotational speed of the electric motor;
adjusting, based on the rotational speed of the electric motor, at least one observer gain coefficient of an observer gain matrix of a Luenberger Current Observer (LCO); and
determining, using the LCO, an estimated motor current of the electric motor.

2. The method of claim 1, wherein the electric motor is a permanent magnet synchronous machine (PMSM).

3. The method of claim 1, wherein adjusting the at least one of the observer gain coefficients includes adjusting two of the observer gain coefficients based on the rotational speed of the electric motor.

4. The method of claim 1, wherein adjusting the at least one of the observer gain coefficients includes adjusting the at least one of the observer gain coefficients as a linear function of the rotational speed of the electric motor.

5. The method of claim 1, wherein the observer gain matrix has the form
$$K = {[ \begin{matrix}{k}_{1} & {k}_{2} & {k}_{3} & {k}_{4} \\ {k}_{5} & {k}_{6} & {k}_{7} & {k}_{8}\end{matrix} ]}^{T}$$
and k₁, k₂, . . . k₈ are the observer gain coefficients.

6. The method of claim 1, wherein measuring the at least one phase current includes measuring exactly one phase current by a phase current sensor.

7. The method of claim 1, wherein estimating the estimated motor current of the electric motor includes determining, by the LCO, an estimated d-axis current of the electric motor and an estimated q-axis current of the electric motor.

8. The method of claim 7, wherein estimating the estimated motor current of the electric motor includes computing, using a dq-abc transformer, estimated phase currents of the electric motor based on the estimated d-axis current and the estimated q-axis current of the electric motor.

9. The method of claim 1, wherein estimating the estimated motor current of the electric motor includes:
determining a preliminary estimated motor current based on the at least one phase current; and
refining, by the LCO, the preliminary estimated motor current to determine the estimated motor current of the electric motor.

10. The method of claim 1, further comprising:
determining a voltage signal based on the estimated motor current of the electric motor; and
commanding, based on the voltage signal, an inverter to supply an alternating current (AC) power to the electric motor.

11. The method of claim 10, further comprising:
determining a requested motor current based on one of a requested speed or a requested torque;
determining a difference between the requested motor current and the estimated motor current; and
wherein determining the voltage signal based on the estimated motor current of the electric motor further includes determining the voltage signal based on the difference between the requested motor current and the estimated motor current.

12. A motor drive system, comprising:
an inverter having at least one pair of switches operable to supply an alternating current (AC) power to an electric motor;
a current sensor configured to measure at least one phase current in the electric motor;
a sensor configured to measure a rotational speed of the electric motor; and
a controller configured to:
adjust, based on the rotational speed of the electric motor, at least one observer gain coefficient of an observer gain matrix of a Luenberger Current Observer (LCO); and
determine, using the LCO, an estimated motor current of the electric motor.

13. The motor drive system of claim 12, wherein the controller is further configured to adjust at least one of the observer gain coefficients by adjusting the at least one of the observer gain coefficients as a linear function of the rotational speed of the electric motor.

14. The motor drive system of claim 12, wherein the controller is further configured to:
determine a voltage signal based on the estimated motor current of the electric motor; and
command, based on the voltage signal, the inverter to supply the alternating current (AC) power to the electric motor.

15. The motor drive system of claim 14, wherein the controller is further configured to:
determine a requested motor current based on one of a requested speed or a requested torque;
determine a difference between the requested motor current and the estimated motor current; and
wherein the controller being configured to determine the voltage signal based on the estimated motor current of the electric motor includes the controller being further configured to determine the voltage signal based on the difference between the requested motor current and the estimated motor current.

16. The motor drive system of claim 12, wherein the observer gain matrix has the form
$$K = {[ \begin{matrix}{k}_{1} & {k}_{2} & {k}_{3} & {k}_{4} \\ {k}_{5} & {k}_{6} & {k}_{7} & {k}_{8}\end{matrix} ]}^{T}$$
and k₁, k₂, . . . k₈ are the observer gain coefficients.

17. The motor drive system of claim 12, wherein determining the estimated motor current of the electric motor further includes determining, by the LCO, an estimated d-axis current of the electric motor and an estimated q-axis current of the electric motor.

18. The motor drive system of claim 17, wherein determining the estimated motor current of the electric motor includes computing, using a dq-abc transformer, estimated phase currents of the electric motor based on the estimated d-axis current and the estimated q-axis current of the electric motor.

19. The motor drive system of claim 12, wherein determining the estimated motor current of the electric motor further includes:
determining a preliminary estimated motor current based on the at least one phase current; and
refining, by the LCO, the preliminary estimated motor current to determine the estimated motor current of the electric motor.

20. The motor drive system of claim 12, wherein the current sensor includes a phase current sensor configured to measure the at least one phase current as exactly one phase current.
